(19) United States
(12) Patent Application Publication
(10) Pub. No.: US 2025/0209332 A1
(43) Pub. Date: Jun. 26, 2025

(54) ENHANCED TELECOMMUNICATIONS NETWORKS CONDUCTIVE LINE HEALTH ANALYSIS AFTER EVENTS

(71) Applicant: CenturyLink Intellectual Property LLC, Denver, CO (US)

(72) Inventors: Ruiqin ZHANG, Broomfield, CO (US); Thomas C. WOLDAHL, Phoenix, AZ (US); Maia J. FRIESER, Broomfield, CO (US)

(73) Assignee: CenturyLink Intellectual Property LLC, Denver, CO (US)

(21) Appl. No.: 18/975,992

(22) Filed: Dec. 10, 2024

Related U.S. Application Data
(60) Provisional application No. 63/613,388, filed on Dec. 21, 2023.

(51) Int. Cl. G06N 3/084; H04L 41/16

(52) U.S. Cl. CPC G06N 3/084; H04L 41/16

(57) ABSTRACT

This disclosure describes systems, methods, and devices related to automatically analyzing local loops of telecommunications networks. A method may include obtaining event data indicative of an event occurring in a local loop of a telecommunications network; generating a query requesting instrumentation-level data for the local loop, including first data prior to the event and second data after the event with a time buffer in between the first data and the second data; obtaining, by a computing device communicatively coupled with the local loop, responsive to the query, the instrumentation-level data; generating, using a machine learning model, a maintenance decision for the local loop based on whether the first data and the second data indicate that performance of the local loop improved or did not improve after the event; and providing, responsive to the query, the maintenance decision.

### CROSS-REFERENCE TO RELATED APPLICATIONS

This application claims the benefit of priority from U.S. Provisional Application No. 63/613,388, filed Dec. 21, 2023, which is incorporated herein by reference in its entirety.

This application is related to U.S. patent application Ser. No. 18/199,198, filed May 18, 2023, titled “SYSTEMS, METHODS, AND STORAGE MEDIA FOR TESTING LOCAL LOOPS OF TELECOMMUNICATIONS NETWORKS,” published as U.S. Publication No. 2023/0291829, to U.S. patent application Ser. No. 17/974,006, filed Oct. 22, 2022, titled “SYSTEMS AND METHODS FOR PRIORITIZING REPAIR AND MAINTENANCE TASKS IN TELECOMMUNICATIONS NETWORKS,” published as U.S. Publication No. 2023/0134035, to U.S. patent application Ser. No. 17/812,858, filed Jul. 15, 2022, titled “SYSTEMS AND METHODS FOR IDENTIFYING DEFECTS IN LOCAL LOOPS,” published as U.S. Publication No. 2023/0013462, to U.S. patent application Ser. No. 17/687,318, filed Mar. 4, 2022, titled “SYSTEMS, METHODS, AND STORAGE MEDIA FOR TESTING LOCAL LOOPS OF TELECOMMUNICATIONS NETWORKS,” issued as U.S. Pat. No. 11,659,081, to U.S. patent application Ser. No. 17/128,737, filed Dec. 21, 2020, titled “SYSTEMS, METHODS, AND STORAGE MEDIA FOR TESTING LOCAL LOOPS OF TELECOMMUNICATIONS NETWORKS,” issued as U.S. Pat. No. 11,277,509, to U.S. patent application Ser. No. 16/680,275, filed Nov. 11, 2029, titled “SYSTEMS, METHODS, AND STORAGE MEDIA FOR TESTING LOCAL LOOPS OF TELECOMMUNICATIONS NETWORKS,” issued as U.S. Pat. No. 10,880,430, the entire contents of which are incorporated herein by reference for all purposes.

### TECHNICAL FIELD

Embodiments of the present disclosure generally relate to systems and methods for assessing telecommunications networks conductive line health after events.

### BACKGROUND

Some telecommunications systems transmit information by sending electrical signals over conductive wire used in loops between end users and telecommunications network equipment.

Some events may undermine the performance of the conductive wire used in the loops of telecommunications networks.

### SUMMARY

According to some embodiments, a method for automatically analyzing local loops of telecommunications networks is disclosed, which according to some embodiments, can include: obtaining event data indicative of an event occurring in a local loop of a telecommunications network; generating a query requesting instrumentation-level data for the local loop, the instrumentation-level data comprising first data prior to the event and second data after the event with a time buffer in between the first data and the second data; obtaining, by a computing device communicatively coupled with the local loop, responsive to the query, the instrumentation-level data; generating, using a machine learning model trained to predict local loop performance outcomes based on local loop event data and local loop instrumentation-level data, a maintenance decision for the local loop based on whether the first data and the second data indicate that performance of the local loop improved or did not improve after the event; and providing, responsive to the query, the maintenance decision.

According to some embodiments, a system for automatically analyzing local loops of telecommunications networks is disclosed, which in some embodiments can include: memory coupled to at least one processor of a device communicatively coupled to a local loop of a telecommunications network, the memory storing instructions that, when executed by the at least one processor, cause the at least one processor to: obtain event data indicative of an event occurring in a local loop of a telecommunications network; generate a query requesting instrumentation-level data for the local loop, the instrumentation-level data comprising first data prior to the event and second data after the event with a time buffer in between the first data and the second data; obtain, responsive to the query, the instrumentation-level data; generate, using a machine learning model trained to predict local loop performance outcomes based on local loop event data and local loop instrumentation-level data, a maintenance decision for the local loop based on whether the first data and the second data indicate that performance of the local loop improved or did not improve after the event; and provide, responsive to the query, the maintenance decision.

According to some embodiments, a non-transitory computer-readable media having instructions encoded thereon is disclosed, where instructions, when executed by at least one processor are operable to: obtain event data indicative of an event occurring in a local loop of a telecommunications network; generate a query requesting instrumentation-level data for the local loop, the instrumentation-level data comprising first data prior to the event and second data after the event with a time buffer in between the first data and the second data; obtain, by a computing device communicatively coupled with the local loop, responsive to the query, the instrumentation-level data; generate, using a machine learning model trained to predict local loop performance outcomes based on local loop event data and local loop instrumentation-level data, a maintenance decision for the local loop based on whether the first data and the second data indicate that performance of the local loop improved or did not improve after the event; and provide, responsive to the query, the maintenance decision.

### BRIEF DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 illustrates an example telecommunications system for automatically identifying and assessing impairments of local loops, in accordance with one embodiment.

FIG. 2 shows example instrumentation-level data for automatically identifying and assessing impairments of local loops, in accordance with one embodiment.

FIG. 3 shows an example process for extracting instrumentation-level data from local loops and evaluating outcomes and instrumentation health, in accordance with one embodiment.

FIG. 4 is an example machine learning model for evaluating outcomes and instrumentation health, in accordance with one embodiment.

FIG. 5 is a flow diagram of an example process for extracting instrumentation-level data from local loops and evaluating outcomes and instrumentation health, in accordance with one embodiment.

FIG. 6 is a diagram illustrating an example of a computing system that may be used in implementing embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed herein, the instant disclosure provides systems, methods, and the like, for assessing telecommunications networks conductive line health after events.

In telecommunications systems, conductive and optical wires are used to transmit electrical signals. For example, telecommunications systems may include end user devices such as modems that are typically connected using wires to form a loop with a switch or other telecommunications network equipment that may communicate with the end user devices and a broader network backbone. A loop (e.g., circuit) may support multiple end user devices, and network equipment may be connected to one or multiple loops.

Telecommunications providers sometimes dispatch technicians, but evaluating the success of a telecommunications technician dispatch currently is not facilitated at an instrumentation level. Typically, a technician dispatch is memorialized with documentation indicating what occurred at the dispatch (e.g., problems identified, solutions applied, etc.), technician interpretations of the dispatch events, and whether a customer follows up (e.g., a customer service call) a dispatch with a similar issue. However, there is no current technique for assessing the success of a dispatch at an instrumentation level (e.g., based on data such as bits-per-tone, H log, quiet line noise data, and signal-to-noise ratio), which can provide more accurate assessments than currently used techniques.

In one or more embodiments, a pre-dispatch and post-dispatch analysis of telecommunications system instrumentation changes may facilitate an assessment of a technician dispatch in a way that cannot be performed without access to data from the instrumentation. Typically, acquiring instrumentation-level data from telecommunications system assets may be manually cumbersome. Automating the instrumentation-level dispatch assessment of what happens on a circuit before and after events (e.g., dispatches, natural disasters, signal quality degradation, etc.) requires use of enhanced computer-based techniques. For example, the instrumentation data (not private user data, and in compliance with relevant laws) may be retrieved from gateways on the edge of a telecommunications network (e.g., in a customer's home). The instrumentation-level data may be used to assess the performance of a modem and predict a likelihood of whether a customer is going to make an inquiry or complaint to the systems provider.

In one or more embodiments, one or more computing devices may be communicatively coupled with a local loop of a telecommunications network to retrieve the instrumentation-level data, such as bits-per-tone, attenuation data, trace data, H log data, quiet line noise data, signal-to-noise ratio data, and the like. In this manner, retrieving the instrumentation-level data requires a computer coupled to a telecommunications loop. The computing devices (e.g., a loop testing system) may obtain the instrumentation-level data directly from network devices, from testing devices in communication with a local loop in the network, and/or from a historical line performance data storage. In certain implementations, obtaining the line performance data may include transmitting a request for line performance data from a local loop testing system to a network device capable of collecting such information for a local loop. In response, a network device in the loop may transmit one or more corresponding response messages, including the requested line performance data, to the local loop testing system. In certain implementations, the request message from the local loop testing system 102 may be configured to cause the receiving network device to initiate a line performance test and to collect line performance data. In other implementations, the network device may be configured to periodically sample or otherwise collect line performance data independent of a specific request from the local loop testing system.

The learnings from the instrumentation-based assessment of telecommunications circuit health may be applied to technician behavior and skillsets, disaster recovery, and the like, to inform decisions regarding which technicians to dispatch to telecommunications assets, when, and for which diagnostic and repair operations.

The instrumentation-level data may be used to inform processes regarding dispatches and systems maintenance, and may use machine learning to predict when performance issues may occur, what types of maintenance may fix or prevent a performance issue, customer churn, whether a circuit health will improve, and the like. The machine learning outputs may be provided to pipelines that may perform feature extraction, determine which technicians to assign to particular equipment based on identified or predicted performance issues, and assign the technicians to the equipment based on the issues and technician skillsets. As a result, technical advantages of the present disclosure include more accurate telecommunications system health assessments, reduced computer resources needed for maintenance by avoiding future system degradation, and improved circuit performance.

The pre-dispatch and post-dispatch analysis may include identifying the trigger for the customer contacting the provider (e.g., what type of performance defect), determining whether the defect was resolved so that the customer will not follow up with another report of the defect, and predicting whether the customer will churn (e.g., leave the provider) due to the defect, determining whether the technician used the correct skillset to address the defect (e.g., the reason for the dispatch was X, and X was addressed by the dispatch, Y was addressed by the dispatch instead, or no defect was identified and/or corrected).

In some examples, inputs may include events (e.g., field dispatch, inclement weather events, technician trouble codes input for dispatches, technician comments indicating actions performed in a dispatch, locations, etc.) and the machine learning outputs. The testing system may perform data extraction on the inputs to retrieve circuit data both pre-and post-event, with a buffer time window in between. The extraction may use structured query language (SQL), including the techniques described above. The testing system may examine the circuit data, such as circuit condition on error values, signal-to-noise ratio, and the like. The testing system also may evaluate outcomes, including overselling, overprovisioning, underperforming, and normal. The testing system may determine whether a circuit was oversold or overprovisioned, whether the circuit health was improved relative to the pre-event data, whether circuit health further degraded relative to the pre-event data, or whether the circuit health remained unchanged relative to the pre-event data. Subsequent actions based on the assessment may include repairs, field dispatches, and the like.

The extraction query used to retrieve and analyze the instrumentation-level data may include a definition of the pre-event and post-event time of the requested data, along with requests to analyze the data and determine whether the circuit health is better, worse, or the same post-event compared to pre-event. In contrast, a manual retrieval and analysis process requires a user to manually retrieve individual data entries and assess them after retrieval. In this manner, another technical advantage of the enhanced techniques herein includes the assessment provided as an output in response to the query rather than the query returning the data and then needing an assessment to be performed for the circuit health.

The machine learning may be used to predict when customers are more likely and less likely to experience equipment performance issues and place customer service calls. For example, a user's equipment may have a performance issue one day and may not contact the provider that day, but they may contact the provider the next day to report the issue. The machine learning may learn that certain times of day or days of the year are more likely to receive customer service calls (e.g., based on when users are more likely to be using equipment and experience the performance issues, such as based on weather events, when equipment shows higher or lower usage, when users are more likely to be on vacation, etc.).

The assessment of instrumentation-level data for circuit health may include analysis of the bitstream to/from the devices in the circuit. In the frequency domain, the bitstream may be analyzed for the number of bits at any tone. Using the bits per tone, a bit value stream may be generated, including each bit value for the respective tones. The loop testing system may analyze the bit value string for bit patterns indicative of impairments in the circuit. The loop testing system may analyze other instrumentation-level data such as H log data, QLN (quiet line noise data), and signal-to-noise ratio (SNR). Using such instrumentation-level data from circuit equipment may improve the accuracy of identifying and predicting equipment impairments, customer service calls, and customer churn, for example, when compared to existing analysis of circuit event data.

The machine learning analysis on the instrumentation-level data may use a gradient boosting technique (e.g., a distributed gradient-boosted decision tree for regression, classification, and ranking), a random forest technique (e.g., supervised machine learning using decision trees to perform regression and classification), decomposition (e.g., breaking down features into smaller features for classification), clustering (e.g., unsupervised learning to divide data into groups with similar features), and/or linear or logistic regression, for example. The machine learning may analyze time-series signals of the instrumentation-level data to perform pre-event and post-event assessments of whether a circuit improved or not after an event, to predict when a performance issue may occur, and/or to predict which corrective measures should be implemented in a circuit.

The machine learning for circuit assessment may learn signal signatures from the instrumentation-level data based on equipment and operating similarities. For example, an above-ground cable in a hot environment may behave differently than an in-ground cable in a colder climate. The machine learning may learn from instrumentation-level data of like-equipment in like-conditions to identify and predict circuit health in this manner. The criterion with which the machine learning evaluates the circuit for performance issues may vary based on operating conditions that may change at different times (e.g., due to weather, higher/lower usage times, etc.). Given the outcomes of dispatches, the machine learning also may predict which dispatches and maintenance operations are likely to be effective and not.

The above descriptions are for purposes of illustration and are not meant to be limiting. Numerous other examples, configurations, processes, etc., may exist, some of which are described in greater detail below. Example embodiments will now be described with reference to the accompanying figures.

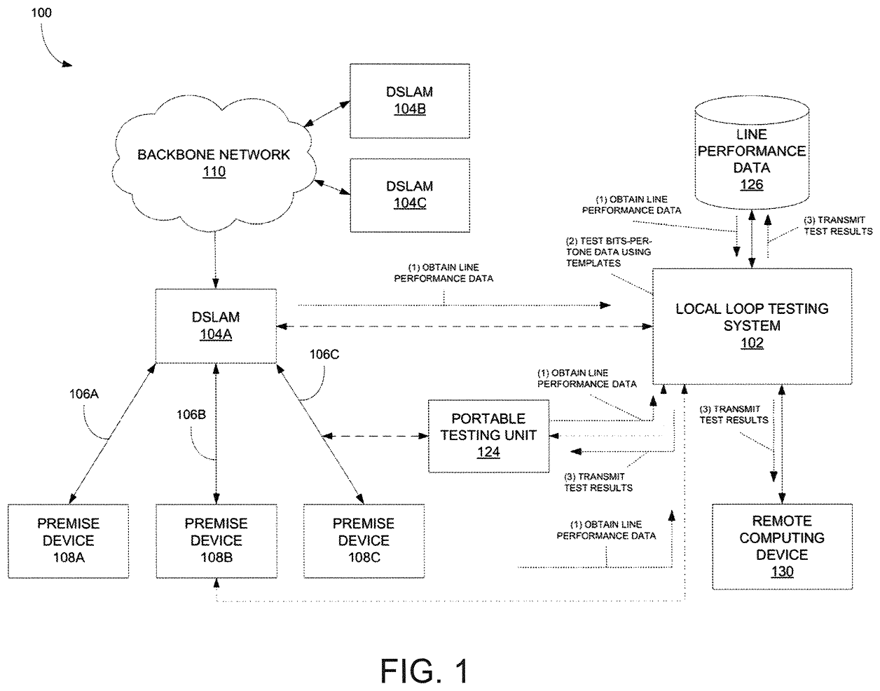

FIG. 1 shows an example telecommunications system for automatically identifying impairments of local loops, in accordance with one embodiment.

Referring to FIG. 1, the network environment 100 includes an local loop testing system 102 configured to automatically identify and assess impairments in circuits of telecommunications networks, such as local loops, based on line performance data for the circuits. Although implementations of the present disclosure are generally applicable to telecommunications networks having any suitable configuration, the network environment 100 of FIG. 1 is provided as an example to lend context to the following discussion. Accordingly, the network environment 100 should be considered as one example environment within which aspects of the present disclosure may be implemented and should not be viewed as limiting.

As illustrated, the network environment 100 includes a backbone network 110 in communication with multiple bridge devices, namely, digital subscriber line (DSL) access multiplexers (DSLAMs) 104A-1040. In general, DSLAMs 104A-1040 facilitate communication between the high-speed backbone network 110 and local loops of the telecommunications network, such as local loops 106A-106C, which are shown as being in communication with DSLAM 104A. More specifically and with reference to DSLAM 104A, the DSLAM 104A collects and combines traffic from network devices, such as premise devices 108A-1080, connected to the local loops 106A-106C for transmission over the backbone network 110 and distributes traffic received from the backbone network 110 to the appropriate local loops 106A-106C.

While the network environment 100 of FIG. 1 illustrates only three DSLAMs 104A-1040, it should be understood that any suitable number of DSLAMs may be in communication with the backbone network 110. Similarly, each DSLAM may be connected to any number of local loops, each of which may be connected to a respective premise device. For example, DSLAMs 104B and 104C may be coupled to one or more respective local loops; however, for clarity, such local loops are omitted from FIG. 1. Moreover, it should be further appreciated that implementations of the present device are not necessarily limited to those including DSLAMs as bridge devices. Rather, as discussed below, implementations of the present device are directed to analyzing and assessing impairments on the local loops 106A-106C. Accordingly, implementations of the present disclosure may include any suitable bridge device for connecting one or more local loops or similar circuits to another network.

A given local loop may be or may become subject to one or more impairments that may negatively impact, bandwidth of the local loop, transmission speed, data quality, and the like. Accordingly, each local loop may be periodically tested to determine whether any such impairments are present. One approach to detecting such impairments is to sample and analyze bits-per-tone data for the local loop. Bits-per-tone data refers to analysis data indicating the number of bits carried by each available tone of the local loop, with each tone corresponding to a range of the total bandwidth of the local loop. For example, in certain applications, each tone may correspond to approximately 4.3 kHz and may carry up to 15 bits. Various impairments affect the bits-per-tone data differently, e.g., by creating gaps or patterns in adjacent frequency bands of the bits-per-tone data. Accordingly, by examining the bits-per-tone data and identifying impairment-related patterns within the bits-per-tone data, impairments may be identified and classified and corresponding remedial actions (e.g., line repairs, equipment replacement, etc.) may be initiated.

The local loop testing system 102 may request the instrumentation-level performance data from the local loops 106A-106C and/or from the line performance data source 126. The local loop testing system 102 may generate queries defining the features to extract from the event and instrumentation-level data, and the pre-and post-event time periods for the features. The instrumentation-level data may include, for example, bitstream data, H log data, QLN data, and SNR data. The response to a query may include the data (e.g., a delta of the pre-and post-event data) and the analysis of the data, including any performance issues identified or predicted, recommended technician dispatches and actions, likelihood of customer service calls, and/or likelihood of customer churn. The local loop testing system 102 may use machine learning as described herein to generate the response queries.

The local loop testing system 102 may receive instrumentation-level data including bits-per-tone data, H log data, QLN, and SNR data for one or more local loops 106A-106C. The instrumentation-level data may be collected using various techniques. In general, the local loop testing system 102 obtains the instrumentation-level data either directly from devices within the network environment 100, from testing devices in communication with the local loop testing system 102, or from a data source of historical instrumentation-level data (e.g., line performance data source 126). For example, in certain implementations, the DSLAM 104A may be configured to periodically collect instrumentation-level data for one or more of the local loops 106A-106C connected to the DSLAM 104A. The collected instrumentation-level data may then be transmitted to the local loop testing system 102 for storage in a line performance data source 126. Alternatively, the collected instrumentation-level data may be transmitted and stored in the line performance data source 126 for subsequent access by the local loop testing system 102 by the DSLAM 104A or one or more other computing systems in communication with the DSLAM 104. In still other implementations, the instrumentation-level data may be collected and provided to the local loop testing system 102 (or other computing system for storage in the line performance data source 126) by a portable testing unit 124 capable of obtaining instrumentation-level data from the local loops 106A-106C. In other implementations, a premise device (e.g., premise device 108B) capable of collecting instrumentation-level data for the local loop (e.g., local loop 106B) may provide the instrumentation-level data to the local loop testing system 102 (or a data source accessible by the local loop testing system 102.

The instrumentation-level data may be in various forms and formats based on the type of device collecting the instrumentation-level data and/or the approach used to store the instrumentation-level data. In general, however, the instrumentation-level data includes bits-per-tone data that indicates a quantity of bits for each of a series tones. Accordingly, the bits-per-tone data may be stored and retrieved as an array, table, string, or similar data structure from which bit counts for specific tones may be identified. In certain implementations, the line performance data including the bits-per-tone data may be in a comma-separated value (CSV) file or similar tabular file format. In other implementations, the line performance data may be received as an extensible markup language (XML) file or similar format that similarly facilitates identification and extraction of particular data from the file by including specific fields identifying particular type of data.

In certain implementations, obtaining the instrumentation-level data may include transmitting a request for instrumentation-level data from the local loop testing system 102 to a network device capable of collecting such information for a local loop. For example, in the network environment 100, the local loop testing system 102 may transmit a request for instrumentation-level data for one, multiple, or all local loops to DSLAM 104A. In response, the DSLAM 104A may transmit one or more corresponding response messages, including the requested instrumentation-level data, to the local loop testing system 102.

In certain implementations, the request message from the local loop testing system 102 may be configured to cause the receiving network device to initiate a line performance test and to collect the instrumentation-level data. In other implementations, the network device may be configured to periodically sample or otherwise collect instrumentation-level data independent of a specific request from the local loop testing system 102. In such implementations, in response to receiving a request from the local loop testing system 102, the network device may provide the most recently collected instrumentation-level data to the local loop testing system 102.

Subsequent to obtaining the instrumentation-level data, the local loop testing system 102 generates a bit value string from the bits-per-tone data (operation 204). For example, in certain implementations, the local loop testing system 102 may concatenate the bits-per-tone data into a string of consecutive hexadecimal values with each value corresponding to the number of bits for a respective tone. Accordingly, the bit value string generally includes each of the bit values of the bits-per-tone data by tone frequency in sequential order.

For example, as previously noted, the bits-per-tone data may include the quantity of bits (e.g., up to 15) for each of a plurality of consecutive tones at 4.3 kHz intervals. In such an implementation, a set of ten consecutive 4.3 kHz intervals may result in counts of 9, 10, 9, 8, 12, 14, 12, 10, 9, and 6 bits, respectively. Accordingly, to generate the bit value string, the local loop testing system 102 may receive the bit counts and may convert and store the bit counts as a string. Using the foregoing example sequence of bits, the local loop testing system 102 would generate the bit value string “9A98CECA96”.

In one example, the local loop testing system 102 may test the bit value string using a bit value template for identifying alien ingress. In at least certain cases, alien ingress may be identified by bands within the bits-per-tone data for which zero bits are received. So, for example, a bit value template for testing for alien ingress may check for portions of the bit value string in which a series of tones having relatively high bit counts (e.g., four or greater) is followed by a band of one or more tones having a bit count of zero, followed by a subsequent band of tones for which relatively high bit counts are again observed.

As another example, the local loop testing system 102 may test the bit value string using a bit value template for identifying bridge taps. In at least certain cases, bridge taps may be identified by bands of the bits-per-tone data in which the bit counts for successive tone ranges decrease over a first band of tones and then increase over a second, consecutive band. When plotted in a bits-per-tone graph, for example, the bridge tap may appear as consecutive series or steps in opposite directions (e.g., a set of downward or upward steps followed by a corresponding set of upward or downward steps, respectively) or stepped crenellations. Accordingly, a search pattern for identifying bridge taps may be configured to identify portions of the bits-per-tone data in which the bit count decreases in a step-like fashion over a first band and then increases in a similar step-like fashion over a second, adjacent band.

As still another example, the local loop testing system 102 may test the bit value string using a bit value template for identifying mixed technology. For purposes of this disclosure, mixed technology generally refers to instances in which the same local loop provides services using multiple, disparate technologies (e.g., a ADSL with ADSL2 or VDSL technologies). Among other things, identification of mixed technology impairments enables an operator to identify old or obsolete technology within a network and for which replacement with newer, improved technology may result in a better overall customer experience. In at least certain cases, mixed technology may be identified from the bits-per-tone data using a search pattern that identifies increasing bits-per-tone values over a range of relatively low-frequency tones. For example, mixed technology may be identified by a search pattern that identifies a gradual increase in the bits-per-tone values over the first 256 bins of the bits-per-tone data (e.g., the bits-per-tone measured for tone frequencies up to approximately 1.1 MHz).

In yet another example, the local loop testing system 102 may test the bit value string using a bit value template for identifying upstream pressure. For purposes of this disclosure, upstream pressure refers to instances in which data is transported upstream using bands that are not generally intended for such data transport. As discussed below in further detail, tones carried by a local loop may be divided into multiple bands dedicated to upstream and downstream data transport. For example, a VDSL circuit may include at least three bands for upstream data transport (e.g., U0, U1, U2) with only two such bands (e.g. U1, U2) providing the primary data transport. To the extent the third band (e.g., U0) is used, such overflow may be the result of attenuation of the circuit in one of the other two bands. In at least certain cases, upstream pressure may be identified using a search pattern that identifies a sudden increase in bits-per-tone values across a small band. For example and without limitation, in at least one implementation, the local loop testing system 102 may identify the presence of upstream pressure by using a search pattern that identifies a first band where each tone has zero bits, a second band (e.g., of approximately 10-30 tones) immediately following the first band for which the bits-per-tone data exceeds a predetermined value (e.g., 5 bits), and a third band immediately following the second band where each tone again has zero bits. It should be appreciated that the length of each of the bands and the predetermined value used in the search pattern may vary in different implementations of the present disclosure. Among other things, the definitions of the bands may vary depending on the technology implemented using the local loop (e.g., ADSL, VDSL, VDSL2, etc.) and their respective band definitions. It should also be appreciated that certain technologies (e.g., VDSL) may support multiple band definitions/configurations. In such cases, the search pattern may also vary or otherwise be dependent on the particular configuration for the technology.

In another example, the local loop testing system 102 may test the bit value string using a bit value template for identifying a noise floor. A noise floor generally refers to when erroneous background transmissions emitted by other devices or sources create interference on frequencies carried over the local loop. In general, a noise floor may be identified by one or more bands in the bits-per-tone data for which each tone has a relatively low bits-per-tone value. For example, in at least certain cases, a noise floor may be considered to be present when each tone of the bits-per-tone data for a band of approximately 2.5-3.5 MHz is seven bits or less. Nevertheless, it should be appreciated that the width of the band, the number of bits used for the threshold, or similar aspects of the bit pattern may vary in implementations of this disclosure. Among other things, the width or range of the band tested using the search pattern may depend on defined bands for the particular data transport technology implemented using the local loop. In such instances, the search pattern may be used to test for a noise floor within a specific upstream or downstream band as defined for the data transport technology. As another example, the threshold number of bits for identifying a noise floor for the search pattern may vary based on a desired quality of service/speed for the local loop and, as a result, the necessary sensitivity to noise on the local loop.

Once a performance issue is identified as an event, the local loop testing system 102 may query the pre-event and post-event data with a buffer time before and after the event. The query may trigger an evaluation of outcomes and an evaluation of instrumentation condition. For example, the evaluation of instrumentation condition may determine whether the instrumentation performance of the local loop improved after the even relative to before the event. The evaluation of the outcomes may determine whether a performance-related event represents overselling, overprovisioning, underperforming, or normal.

The pre-dispatch and post-dispatch analysis may include identifying the trigger for the customer contacting the provider (e.g., what type of performance defect), determining whether the defect was resolved so that the customer will not follow up with another report of the defect, and predicting whether the customer will churn (e.g., leave the provider) due to the defect, determining whether the technician used the correct skillset to address the defect (e.g., the reason for the dispatch was X, and X was addressed by the dispatch, Y was addressed by the dispatch instead, or no defect was identified and/or corrected).

In some examples, inputs may include events (e.g., field dispatch, inclement weather events, technician trouble codes input for dispatches, technician comments indicating actions performed in a dispatch, locations, etc.) and the machine learning outputs. The testing system may perform data extraction on the inputs to retrieve circuit data both pre-and post-event, with a buffer time window in between. The extraction may use structured query language (SQL), including the techniques described above. The testing system may examine the circuit data, such as circuit condition on error values, signal-to-noise ratio, and the like. The testing system also may evaluate outcomes, including overselling, overprovisioning, underperforming, and normal. The testing system may determine whether a circuit was oversold or overprovisioned, whether the circuit health was improved relative to the pre-event data, whether circuit health further degraded relative to the pre-event data, or whether the circuit health remained unchanged relative to the pre-event data. Subsequent actions based on the assessment may include repairs, field dispatches, and the like.

The extraction query used to retrieve and analyze the instrumentation-level data may include a definition of the pre-event and post-event time of the requested data, along with requests to analyze the data and determine whether the circuit health is better, worse, or the same post-event compared to pre-event. In contrast, a manual retrieval and analysis process requires a user to manually retrieve individual data entries and assess them after retrieval. In this manner, another technical advantage of the enhanced techniques herein includes the assessment provided as an output in response to the query rather than the query returning the data and then needing an assessment to be performed for the circuit health.

The machine learning may be used to predict when customers are more likely and less likely to experience equipment performance issues and place customer service calls. For example, a user's equipment may have a performance issue one day and may not contact the provider that day, but they may contact the provider the next day to report the issue. The machine learning may learn that certain times of day or days of the year are more likely to receive customer service calls (e.g., based on when users are more likely to be using equipment and experience the performance issues, such as based on weather events, when equipment shows higher or lower usage, when users are more likely to be on vacation, etc.).

The assessment of instrumentation-level data for circuit health may include analysis of the bitstream to/from the devices in the circuit. In the frequency domain, the bitstream may be analyzed for the number of bits at any tone. Using the bits per tone, a bit value stream may be generated, including each bit value for the respective tones. The loop testing system may analyze the bit value string for bit patterns indicative of impairments in the circuit. The loop testing system may analyze other instrumentation-level data such as H log data, QLN (quiet line noise data), and signal-to-noise ratio (SNR). Using such instrumentation-level data from circuit equipment may improve the accuracy of identifying and predicting equipment impairments, customer service calls, and customer churn, for example, when compared to existing analysis of circuit event data.

The machine learning analysis on the instrumentation-level data may use a gradient boosting technique (e.g., a distributed gradient-boosted decision tree for regression, classification, and ranking), a random forest technique (e.g., supervised machine learning using decision trees to perform regression and classification), decomposition (e.g., breaking down features into smaller features for classification), clustering (e.g., unsupervised learning to divide data into groups with similar features), and/or linear or logistic regression, for example. The machine learning may analyze time-series signals of the instrumentation-level data to perform pre-event and post-event assessments of whether a circuit improved or not after an event, to predict when a performance issue may occur, and/or to predict which corrective measures should be implemented in a circuit.

The machine learning for circuit assessment may learn signal signatures from the instrumentation-level data based on equipment and operating similarities. For example, an above-ground cable in a hot environment may behave differently than an in-ground cable in a colder climate. The machine learning may learn from instrumentation-level data of like-equipment in like-conditions to identify and predict circuit health in this manner. The criterion with which the machine learning evaluates the circuit for performance issues may vary based on operating conditions that may change at different times (e.g., due to weather, higher/lower usage times, etc.). Given the outcomes of dispatches, the machine learning also may predict which dispatches and maintenance operations are likely to be effective and not.

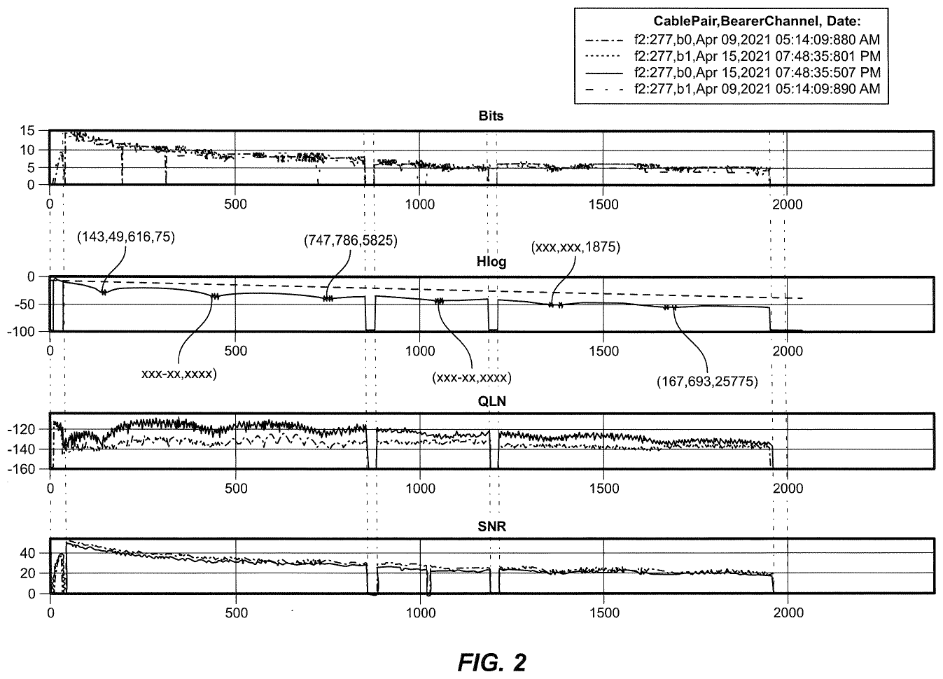

FIG. 2 shows example instrumentation-level data for automatically identifying and assessing impairments of local loops, in accordance with one embodiment.

Referring to FIG. 2, the instrumentation-level data shown may be a subset of instrumentation-level data from the loops of FIG. 1 analyzed to identify and predict circuit impairments, assess whether a circuit improved after an event, and assess outcomes of events. As shown in FIG. 2, the instrumentation-level data may include bits in a bitstream, H log data, QLN data, and SNR.

For example, in instances where the bits-per-tone data exhibits a bridge tap, QLN or H log data may be used to verify whether a bridge tap is actually present (e.g., as indicated by a characteristic “bounce” in the QLN or H log data) or if the results of analyzing the bits-per-tone data is instead the result of alien ingress (e.g., as indicated by spikes or similar characteristic changes at frequencies corresponding to common sources of interference).

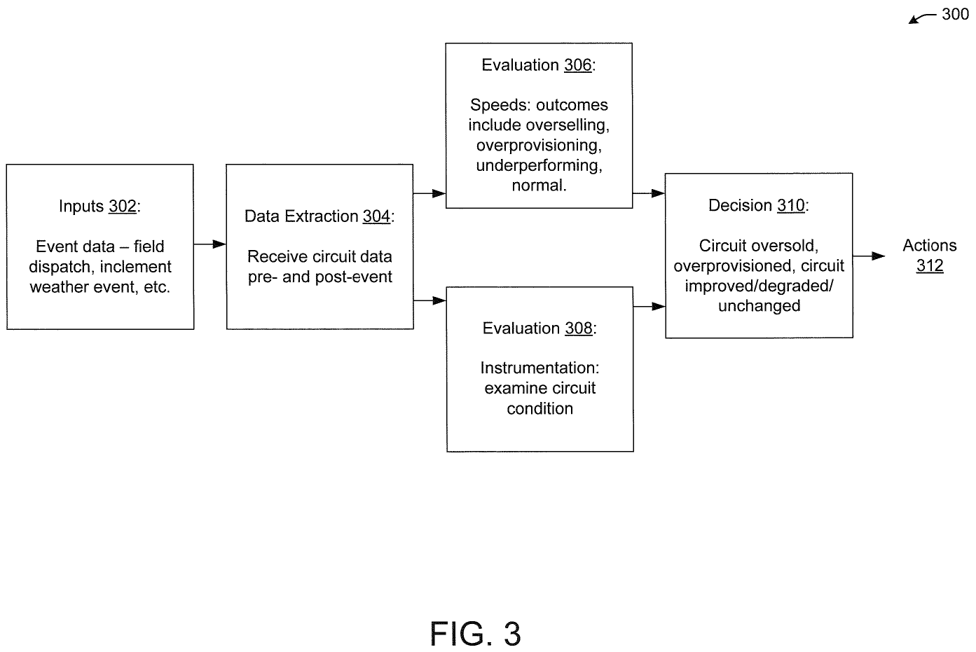

FIG. 3 shows an example process 300 for extracting instrumentation-level data from local loops and evaluating outcomes and instrumentation health, in accordance with one embodiment.

Inputs 302 to the local loop testing system 102 may include event data, such as field dispatches (e.g., which technicians, which technician skillsets, where, when, technician comments from dispatches, technician actions taken, etc.), inclement weather events, traffic events (e.g., events when large spikes in traffic usually occur), etc. Data extraction 304 may include the local loop testing system 102 receiving circuit data (e.g., from the local loops of FIG. 1), both pre-event and post-event with a buffer time in between. The data extraction 304 may include a query (e.g., SQL query) defining the instrumentation-level data features being requested and their times (e.g., the pre-and post-event times based on the times of the events). In response to the query for the instrumentation-level data query, parallel evaluations may be performed: an evaluation 306 for speeds (e.g., outcomes including overselling, overprovisioning, underperforming, and normal), and an evaluation 308 of instrumentation health (e.g., circuit condition on error values, SNR, etc.). The local loop testing system 102 may make a decision 310 based on the evaluation 306 and the evaluation 308, including broad categories such as whether a circuit was oversold or overprovisioned, and/or whether circuit health improved, degraded, or remained unchanged (e.g., comparing the pre-and post-event instrumentation-level data for a circuit).

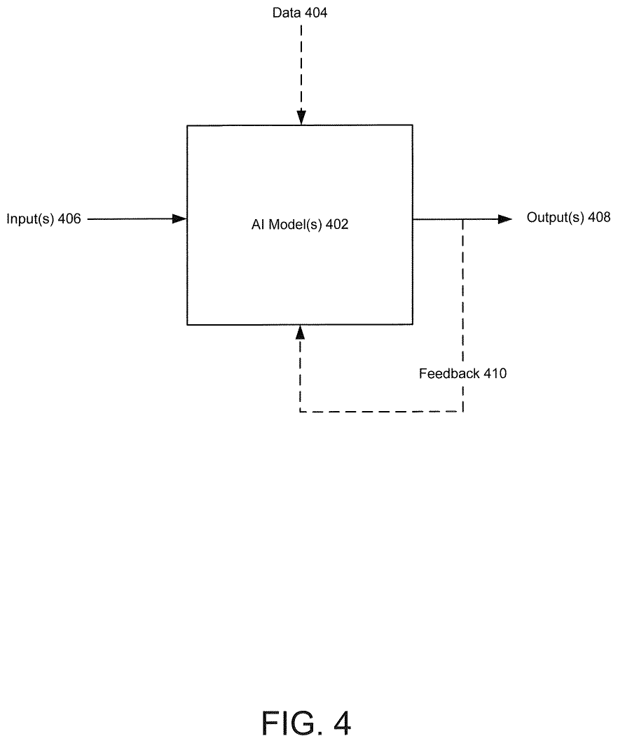

FIG. 4 is an example machine learning model 402 for evaluating outcomes and instrumentation health, in accordance with one embodiment.

Referring to FIG. 4, the machine learning model 402 may be used by the local loop testing system 102 to perform the evaluations 306 and 308, and make the decision 310 of FIG. 3. The machine learning model 402 may use a gradient boosting technique (e.g., a distributed gradient-boosted decision tree for regression, classification, and ranking), a random forest technique (e.g., supervised machine learning using decision trees to perform regression and classification), decomposition (e.g., breaking down features into smaller features for classification), clustering (e.g., unsupervised learning to divide data into groups with similar features), and/or linear or logistic regression, for example. The machine learning may analyze time-series signals of the instrumentation-level data to perform pre-event and post-event assessments of whether a circuit improved or not after an event, to predict when a performance issue may occur, and/or to predict which corrective measures should be implemented in a circuit.

The machine learning model 402 optionally may receive data 404 for training. The data 404 may include instrumentation-level data labeled as normal or indicative of an impairment. The data 404 may include event data corresponding with the instrumentation-level data, allowing the machine learning model 402 to learn which events and maintenance actions are likely to improve circuit health based on various circuit conditions. The machine learning model 402 may receive inputs 406, such as the inputs 302 and the instrumentation-level data from the data extraction 304. The inputs 406 also may include prompts including requested outputs (e.g., outputs 408) for the machine learning model 402 to generate (e.g., commands to make a maintenance/dispatch decision based on the circuit data and the event data, customer churn likelihood, probability of repeat customer calls for a same issue, probability of customer calls at respective times, confidence scores, and the like). The data 404 may represent zero-shot, few-shot, or multi-shot learning depending whether the data include any examples in the inputs 406.

In one or more embodiments, the machine learning model 402 receive feedback 410, such as whether the maintenance decisions improved circuit health, whether customers churned, whether customers called about an impairment, and may adjust its criteria based on the feedback 410 such that, for example, a subsequent similar event and/or instrumentation-level data may result in a different decision 310. Similarly, the machine learning model 402 may iteratively generate decisions and evaluate them until the decisions no longer change after multiple iterations or until a confidence score in the decision exceeds a confidence threshold.

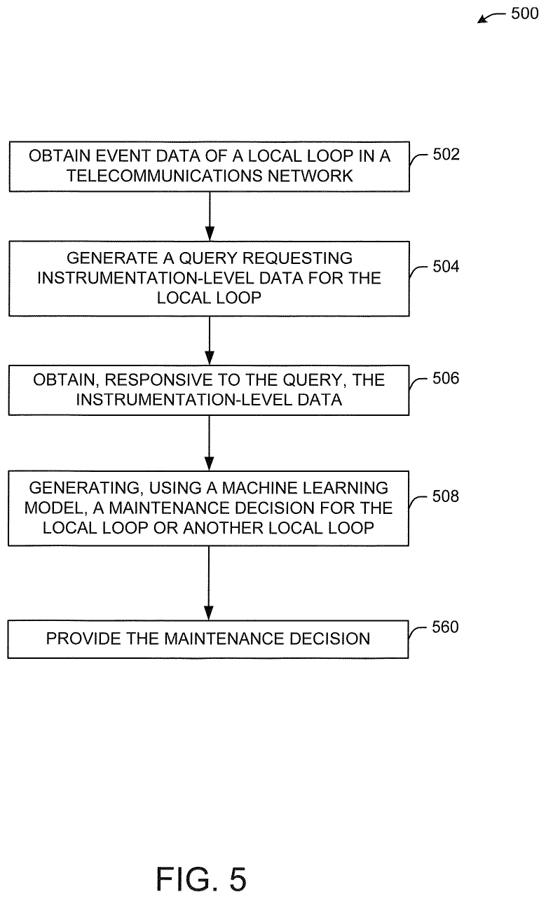

FIG. 5 is a flow diagram of an example process 500 for extracting instrumentation-level data from local loops and evaluating outcomes and instrumentation health, in accordance with one embodiment.

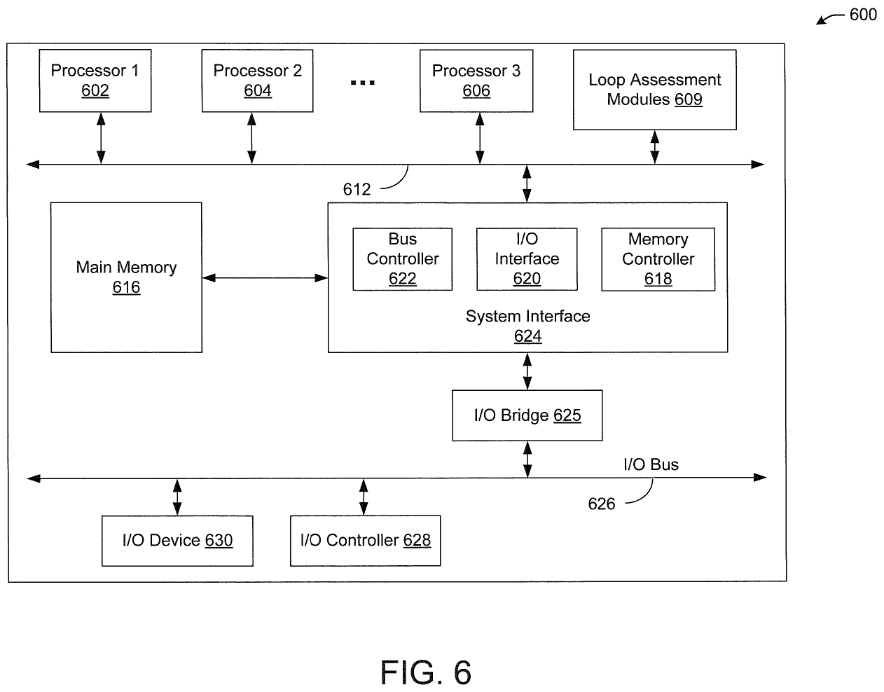

At block 502, a device (or system, e.g., the local loop testing system of FIG. 1, the loop assessment modules 609 of FIG. 6) may obtain event data (e.g., the inputs 302 of FIG. 3) indicative of an event occurring in a local loop (or multiple loops) of a telecommunications network.

At block 504, the device may generate a query (e.g., SQP query) requesting instrumentation-level data for the local loop, the instrumentation-level data comprising first data prior to the event and second data after the event with a time buffer in between the first data and the second data.

At block 506, the device may obtain, responsive to the query, the instrumentation-level data (e.g., the data extraction 304 of FIG. 3).

At block 508, the device may generate, using a machine learning model (e.g., the machine learning model 402 of FIG. 4) trained to predict local loop performance outcomes based on local loop event data and local loop instrumentation-level data, a maintenance decision for the local loop (and/or another local loop in the network) based on whether the first data and the second data indicate that performance of the local loop improved or did not improve after the event.

At block 560, the device may provide the maintenance decision, to be used in a subsequent action such as a dispatch decision or the like.

It is understood that the above descriptions are for purposes of illustration and are not meant to be limiting.

FIG. 66 is a block diagram illustrating an example of a computing device or computer system 600 which may be used in implementing the embodiments of the components of the network disclosed above. For example, the computing system 600 of FIG. 16 may represent at least a portion of the architecture shown in FIG. 1, including the local loop testing system 102, and facilitating the assessments and recommendations of FIG. 1, as discussed above. The computer system (system) includes one or more processors 602-606, and loop assessment modules 609 (e.g., hardware and/or software) capable of facilitating the functions of the local loop testing system 102 of FIG. 1 as described herein. Processors 602-606 may include one or more internal levels of cache (not shown) and a bus controller 622 or bus interface unit to direct interaction with the processor bus 612. Processor bus 612, also known as the host bus or the front side bus, may be used to couple the processors 602-606 with the system interface 624. System interface 624 may be connected to the processor bus 612 to interface other components of the system 600 with the processor bus 612. For example, system interface 624 may include a memory controller 618 for interfacing a main memory 616 with the processor bus 612. The main memory 616 typically includes one or more memory cards and a control circuit (not shown). System interface 624 may also include an input/output (I/O) interface 620 to interface one or more I/O bridges 625 or I/O devices with the processor bus 612. One or more I/O controllers and/or I/O devices may be connected with the I/O bus 626, such as I/O controller 628 and I/O device 630, as illustrated.

I/O device 630 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

System 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. System 600 may include a read only memory (ROM) and/or other static storage device coupled to the processor bus 612 for storing static information and instructions for the processors 602-606. The system outlined in FIG. 6 is but one possible example of a computer system that may employ or be configured in accordance with aspects of the present disclosure.

According to one embodiment, the above techniques may be performed by computer system 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 606 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 616, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations together with all equivalents thereof.

What is claimed is:

1. A method comprising:
obtaining event data indicative of an event occurring in a local loop of a telecommunications network;
generating a query requesting instrumentation-level data for the local loop, the instrumentation-level data comprising first data prior to the event and second data after the event with a time buffer in between the first data and the second data;
obtaining, by a computing device communicatively coupled with the local loop, responsive to the query, the instrumentation-level data;
generating, using a machine learning model trained to predict local loop performance outcomes based on local loop event data and local loop instrumentation-level data, a maintenance decision for the local loop based on whether the first data and the second data indicate that performance of the local loop improved or did not improve after the event; and
providing, responsive to the query, the maintenance decision.

2. The method of claim 1, further comprising:
generating, using the machine learning model, a second maintenance decision for a second local loop of the telecommunications network based on whether the first data and the second data indicate that performance of the local loop improved or did not improve after the event; and
providing, responsive to the query, the second maintenance decision.

3. The method of claim 1, wherein the machine learning model uses a gradient boosting technique.

4. The method of claim 1, wherein the machine learning model uses a random forest technique.

5. The method of claim 1, wherein the machine learning model uses decomposition.

6. The method of claim 1, wherein the machine learning model uses clustering of similar local loops of the telecommunications network.

7. The method of claim 1, wherein the machine learning model uses a linear or logistic regression technique.

8. The method of claim 1, wherein generating the maintenance decision is based on a time-series of the instrumentation-level data.

9. The method of claim 1, wherein the instrumentation-level data comprise bitstream data, H log data, quiet line noise (QLN) data, and signal-to-noise ratio (SNR) data.

10. The method of claim 1, further comprising:
generating, using the machine learning model, a first evaluation of the event data and the instrumentation-level data, the first evaluation indicative of overselling the local loop, overprovisioning the local loop, underperformance of the local loop, or normal operation of the local loop; and
generating, using the machine learning model, a second evaluation of the event data and the instrumentation-level data, the second evaluation indicative of an operating condition of the local loop,
wherein generating the maintenance decision is based on the first evaluation and the second evaluation.

11. A system comprising:
memory coupled to at least one processor of a device communicatively coupled to a local loop of a telecommunications network, the memory storing instructions that, when executed by the at least one processor, cause the at least one processor to:
obtain event data indicative of an event occurring in a local loop of a telecommunications network;
generate a query requesting instrumentation-level data for the local loop, the instrumentation-level data comprising first data prior to the event and second data after the event with a time buffer in between the first data and the second data;
obtain, responsive to the query, the instrumentation-level data;
generate, using a machine learning model trained to predict local loop performance outcomes based on local loop event data and local loop instrumentation-level data, a maintenance decision for the local loop based on whether the first data and the second data indicate that performance of the local loop improved or did not improve after the event; and
provide, responsive to the query, the maintenance decision.

12. The system of claim 11, wherein execution of the instructions further causes the at least one processor to:
generate, using the machine learning model, a second maintenance decision for a second local loop of the telecommunications network based on whether the first data and the second data indicate that performance of the local loop improved or did not improve after the event; and
provide, responsive to the query, the second maintenance decision.

13. The system of claim 11, wherein the machine learning model uses at least one of a gradient boosting technique or a random forest technique.

14. The system of claim 11, wherein the machine learning model uses decomposition.

15. The system of claim 11, wherein the machine learning model uses clustering of similar local loops of the telecommunications network.

16. The system of claim 11, wherein the machine learning model uses a linear or logistic regression technique.

17. The system of claim 11, wherein generating the maintenance decision is based on a time-series of the instrumentation-level data.

18. The system of claim 11, wherein the instrumentation-level data comprise bitstream data, H log data, quiet line noise (QLN) data, and signal-to-noise ratio (SNR) data.

19. The system of claim 11, wherein execution of the instructions further causes the at least one processor to:
generate, using the machine learning model, a first evaluation of the event data and the instrumentation-level data, the first evaluation indicative of overselling the local loop, overprovisioning the local loop, underperformance of the local loop, or normal operation of the local loop; and
generate, using the machine learning model, a second evaluation of the event data and the instrumentation-level data, the second evaluation indicative of an operating condition of the local loop,
wherein to generate the maintenance decision is based on the first evaluation and the second evaluation.

20. A non-transitory computer-readable media having instructions encoded thereon, the instructions, when executed by at least one processor are operable to:
obtain event data indicative of an event occurring in a local loop of a telecommunications network;
generate a query requesting instrumentation-level data for the local loop, the instrumentation-level data comprising first data prior to the event and second data after the event with a time buffer in between the first data and the second data;
obtain, by a computing device communicatively coupled with the local loop, responsive to the query, the instrumentation-level data;
generate, using a machine learning model trained to predict local loop performance outcomes based on local loop event data and local loop instrumentation-level data, a maintenance decision for the local loop based on whether the first data and the second data indicate that performance of the local loop improved or did not improve after the event; and
provide, responsive to the query, the maintenance decision.
